(19) United States
(12) Patent Application Publication
(10) Pub. No.: US 2008/0040104 A1
(43) Pub. Date: Feb. 14, 2008

(54) Speech coding apparatus, speech decoding apparatus, speech coding method, speech decoding method, and computer readable recording medium

(75) Inventor: Hiroyasu Ide, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/890,428

(22) Filed: Aug. 6, 2007

(30) Foreign Application Priority Data
Aug. 7, 2006 (JP) 2006-214741

(51) Int. Cl. G10L 19/00

(52) U.S. Cl. 704/219; 704/E19.001

(57) ABSTRACT

In a speech coding apparatus, a band-pass filter unit separates a residual signal generated by a predictive analyzer into band by band components. Then, a gain calculation unit and a voiced/unvoiced discrimination and pitch extraction unit acquire information on an intensity characterizing each band, information on a result of discrimination as to whether each band-by-band component is a voiced sound or unvoiced sound, and information on a pitch frequency when it is a voiced sound. The acquired information is coded together with a predictive coefficient and is transmitted to a speech decoding apparatus. The speech decoding apparatus generates an excitation signal while reflecting the feature of each band of the original residual signal. This makes the excitation signal an efficient replica of the original residual signal.

### BACKGROUND OF THE INVENTION

1. Field of the Invention

The present invention relates to a speech coding apparatus, speech decoding apparatus, speech coding method, speech decoding method, and computer readable recording medium which execute analysis-synthesis speech coding and speech decoding processes.

2. Description of the Related Art

In a speech compression technique used in cellular phones or the like, technical developments are being made to fulfill the restrictions that, for example, the sampling frequency is 8 kHz and the transmission/reception speed is 4 kbps. The speech compression technique is classified in a low bit-rate speech compression technique in analysis-synthesis speech compression techniques.

A typical analysis-synthesis low bit-rate speech compression technique is, for example, an 8-kbps speech coding method specified in the ITU Recommendation G. 729. In this speech coding method, a speech coding apparatus mainly performs a linear predictive analysis on a speech signal to be processed, thereby generating a predictive coefficient and a residual signal. A speech decoding apparatus receives information on the predictive coefficient and residual signal, and decodes a speech signal based on the information.

As a speech analysis-synthesis method different from a linear predictive analysis, there is an MLSA (Mel Log Spectrum Approximation) analysis known. The speech analysis-synthesis method based on the MLSA analysis is described in, for example, IECE Journal, Vol. J66-A, No. 2, pp. 122-129, 1983, entitled “Mel log spectrum approximation (MLSA) filter for speech synthesis” by Satoshi IMAI, Kazuo SUMITA, and Chieko FURUICHI.

In the speech decoding apparatus, a residual signal generated by the speech coding apparatus is treated as an excitation signal (signal for excitation) for decoding a speech signal using a filter calculated from a predictive coefficient. That is, a residual signal and an excitation signal are merely names different from each other for just the sake of convenience based on whether the viewpoint is on the speech coding apparatus or the speech decoding apparatus, and mean substantially the same signals.

While the analysis-synthesis speech compression technique can make the bit rate lower than the waveform coding type speech compression technique, the quality of a reproduced speech becomes poorer. Recently, therefore, the analysis-synthesis speech compression technique is demanded of an ability to reproduce a speech with higher quality.

For example, IEICE Journal, Vol. J87-D-II, No. 8, pp. 1565-1571, August 2004, entitled “Incorporation of mixed excitation model and postfilter into HMM-based text-to-speech synthesis”, by Takayoshi YOSHIMURA, Keiichi TOKUDA, Takashi MASUKO, Takao KOBAYASHI, and Tadashi KITAMURA, describes that incorporating a mixed excitation model in a text-to-speech system based on an HMM (Hidden Markov Model) can improve the quality of a speech.

Specifically, the journal describes that to synthesize speeches having both a periodic component and a non-periodic component like a voiced spirant, the frequency is divided into a plurality of bands and it is determined for each band whether each component is a voiced speech or an unvoiced speech.

The conventional art described in the journal improves the quality of a speech signal to be decoded by a speech decoding apparatus to some degrees by processing a residual signal band by band.

However, the conventional band-by-band processing of a residual signal does not take the band dependency of the intensity of a residual signal into account.

When a real human speech has a plurality of bands having a pitch property in a residual signal, the pitch intensity generally differs band by band. When a residual signal has a plurality of bands having a noise property, likewise, the intensity of the residual signal generally differs band by band.

That is, the excitation signal of a real speech is not the superimposition of a plurality of pitches of the same intensity. The excitation signal of a real speech is not white noise either.

Therefore, band-by-band processing of a residual signal considering no band dependency of the intensity of the residual signal can cause reduction in the quality of a speech signal to be decoded by the speech decoding apparatus.

### SUMMARY OF THE INVENTION

Accordingly, it is an object of the present invention to provide a speech coding apparatus, speech decoding apparatus, speech coding method, speech decoding method, and computer readable recording medium which can improve the quality of a speech signal to be decoded in coding and decoding a speech.

To achieve the object, a speech coding apparatus according to a first aspect of the invention comprises:

a predictive analyzer that performs a predictive analysis on a speech signal to acquire a predictive coefficient and a residual signal;

a band-by-band residual signal generating unit that separates the residual signal into band-by-band residual signals for respective bands;

an intensity determining unit that acquires band-by-band residual signal intensities from the band-by-band residual signals for the respective bands; and

a coder that codes the predictive coefficient and the band-by-band residual signal intensities for the respective bands.

To achieve the object, a speech decoding apparatus according to a second aspect of the invention comprises:

a receiver that receives a coded predictive coefficient obtained by coding a predictive coefficient acquired by a predictive analysis on a speech signal, and coded band-by-band residual signal intensities obtained by coding band-by-band residual signal intensities respectively indicating intensities for respective bands of a residual signal acquired by the predictive analysis;

a decoder that decodes the predictive coefficient and the band-by-band residual signal intensities for the respective bands from the coded predictive coefficient and the coded band-by-band residual signal intensities;

an excitation signal generating unit that generates, for each of the bands, a band-by-band excitation signal having a band dependency indicated by the band-by-band residual signal intensity;

a residual signal restore unit that restores a residual signal from the band-by-band excitation signals for the respective bands; and

a synthesis filter that combines the predictive coefficient and the restored residual signal to restore a speech.

To achieve the object, a speech coding method according to a third aspect of the invention comprises:

a predictive analysis step of performing a predictive analysis on a speech signal to acquire a predictive coefficient and a residual signal;

a band-by-band residual signal generating step of separating the residual signal into band-by-band residual signals for respective bands;

an intensity determining step of acquiring band-by-band residual signal intensities from the band-by-band residual signals for the respective bands; and

a coding step of coding the predictive coefficient and the band-by-band residual signal intensities for the respective bands.

To achieve the object, a speech decoding method according to a fourth aspect of the invention comprises:

a reception step of receiving a coded predictive coefficient obtained by coding a predictive coefficient acquired by a predictive analysis on a speech signal, and coded band-by-band residual signal intensities obtained by coding band-by-band residual signal intensities respectively indicating intensities for respective bands of a residual signal acquired by the predictive analysis;

a decoding step of decoding the predictive coefficient and the band-by-band residual signal intensities for the respective bands from the coded predictive coefficient and the coded band-by-band residual signal intensities;

an excitation signal generating step of generating, for each of the bands, a band-by-band excitation signal having a band dependency indicated by the band-by-band residual signal intensity;

a residual signal restore step of restoring a residual signal from the band-by-band excitation signals for the respective bands; and

a synthesis step of combining the predictive coefficient and the restored residual signal to restore a speech.

To achieve the object, a computer readable recording medium according to a fifth aspect of the invention has recorded therein a program for allowing a computer to execute:

a predictive analysis step of performing a predictive analysis on a speech signal to acquire a predictive coefficient and a residual signal;

a band-by-band residual signal generating step of separating the residual signal into band-by-band residual signals for respective bands;

an intensity determining step of acquiring band-by-band residual signal intensities from the band-by-band residual signals for the respective bands; and

a coding step of coding the predictive coefficient and the band-by-band residual signal intensities for the respective bands.

To achieve the object, a computer readable recording medium according to a sixth aspect of the invention has recorded therein a program for allowing a computer to execute:

a reception step of receiving a coded predictive coefficient obtained by coding a predictive coefficient acquired by a predictive analysis on a speech signal, and coded band-by-band residual signal intensities obtained by coding band-by-band residual signal intensities respectively indicating intensities for respective bands of a residual signal acquired by the predictive analysis;

a decoding step of decoding the predictive coefficient and the band-by-band residual signal intensities for the respective bands from the coded predictive coefficient and the coded band-by-band residual signal intensities;

an excitation signal generating step of generating, for each of the bands, a band-by-band excitation signal having a band dependency indicated by the band-by-band residual signal intensity;

a residual signal restore step of restoring a residual signal from the band-by-band excitation signals for the respective bands; and

a synthesis step of combining the predictive coefficient and the restored residual signal to restore a speech.

The present invention can improve the quality of a speech signal to be decoded in coding and decoding a speech.

### BRIEF DESCRIPTION OF THE DRAWINGS

These objects and other objects and advantages of the present invention will become more apparent upon reading of the following description and the accompanying drawings in which:

FIG. 1 is a functional configuration diagram of a speech coding apparatus according to an embodiment of the present invention;

FIG. 2 is a functional configuration diagram of a speech decoding apparatus according to the embodiment of the present invention;

FIG. 3 is a diagram showing the physical configuration of a speech coding/decoding apparatus according to the embodiment of the present invention;

FIG. 4 is a flowchart illustrating an MLSA-based predictive analysis process;

FIG. 5 is a flowchart illustrating a linear predictive analysis process;

FIG. 6 is a flowchart illustrating a band-by-band residual signal information generating process;

FIG. 7 is a flowchart illustrating a band-by-band excitation generating process;

FIG. 8 is a flowchart illustrating a noise sequence generating process;

FIG. 9 is a flowchart illustrating a speech signal restoring process;

FIG. 10 is a flowchart illustrating an example of an MLSA filter coefficient calculating process; and

FIGS. 11A and 11B are diagrams showing an example of the configuration of an MLSA filter.

### DETAILED DESCRIPTION OF THE PREFERRED EMBODIMENT

A speech coding apparatus and a speech decoding apparatus according-to a preferred embodiment of the present invention will be elaborated below with reference to the accompanying drawings.

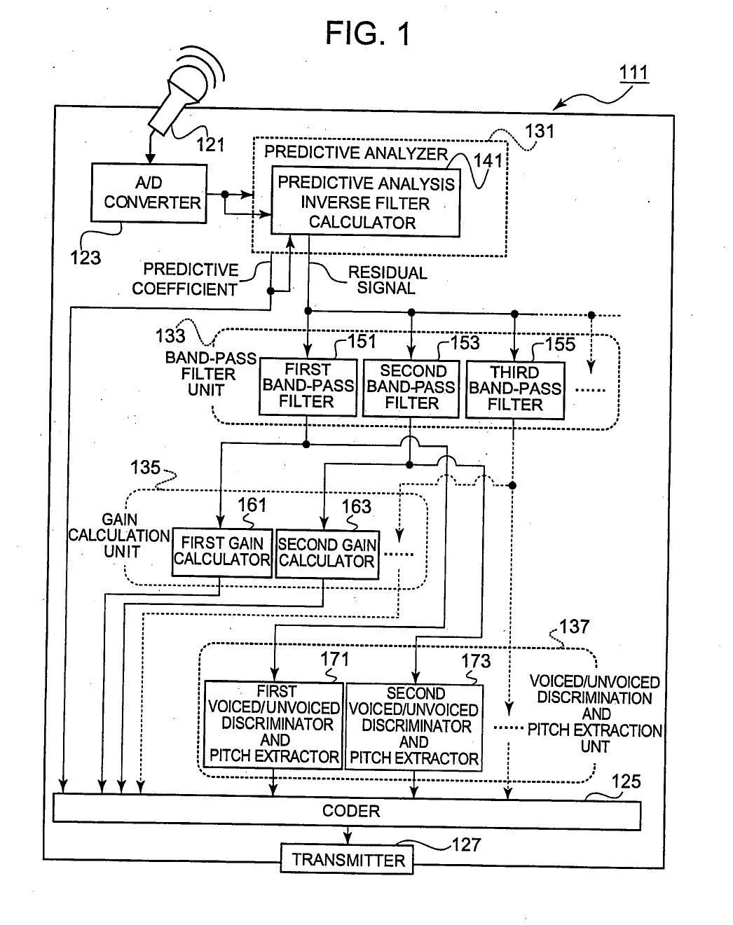

FIG. 1 is a functional configuration diagram of a speech coding apparatus 111 according to the embodiment.

As shown in FIG. 1, the speech coding apparatus 111 includes a microphone 121, an A/D converter 123, a predictive analyzer 131, a band-pass filter unit 133, a gain calculation unit 135, a voiced/unvoiced discrimination and pitch extraction unit 137, a coder 125 and a transmitter 127.

The predictive analyzer 131 incorporates a predictive analysis inverse filter calculator 141.

The band-pass filter unit 133 has a first band-pass filter 151, a second band-pass filter 153, a third band-pass filter 155, and necessary band-pass filters (not shown) following the third band-pass filter 155.

The gain calculation unit 135 has a first gain calculator 161, a second gain calculator 163, and necessary gain calculators (not shown) following the second gain calculator 163.

The voiced/unvoiced discrimination and pitch extraction unit 137 has a first voiced/unvoiced discriminator and pitch extractor 171, a second voiced/unvoiced discriminator and pitch extractor 173, and necessary voiced/unvoiced discriminators and pitch extractors (not shown) following the second voiced/unvoiced discriminator and pitch extractor 173.

First, a speech is input to the microphone 121. The microphone 121 converts the speech to an analog speech signal. The analog speech signal is sent to the A/D converter 123. The A/D converter 123 converts the analog speech signal to a digital speech signal for a discrete process in analysis and coding processes which will be performed later. The digital speech signal is sent to the predictive analyzer 131.

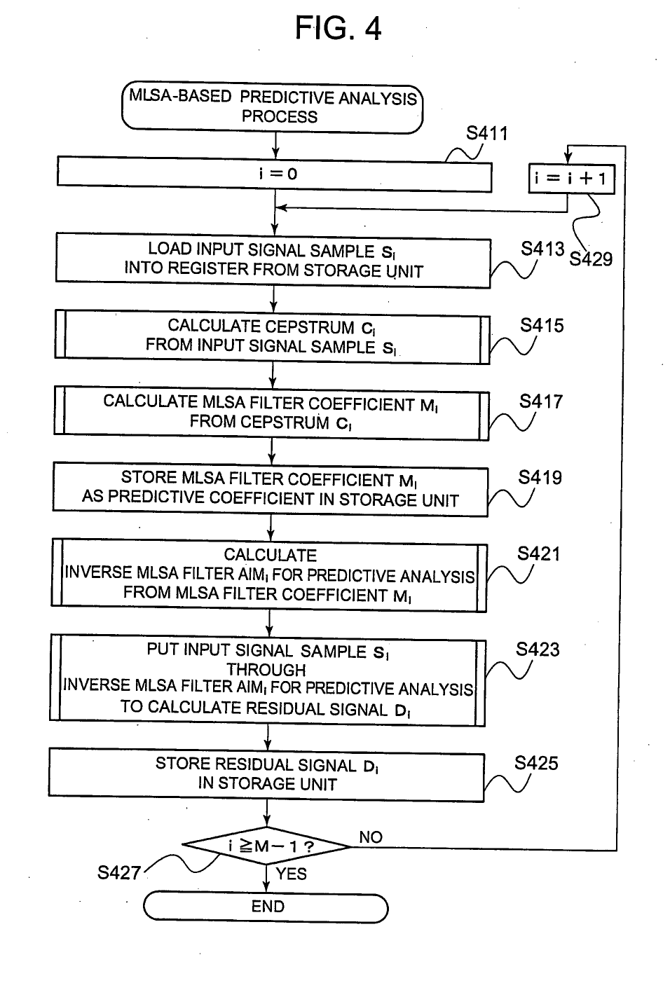

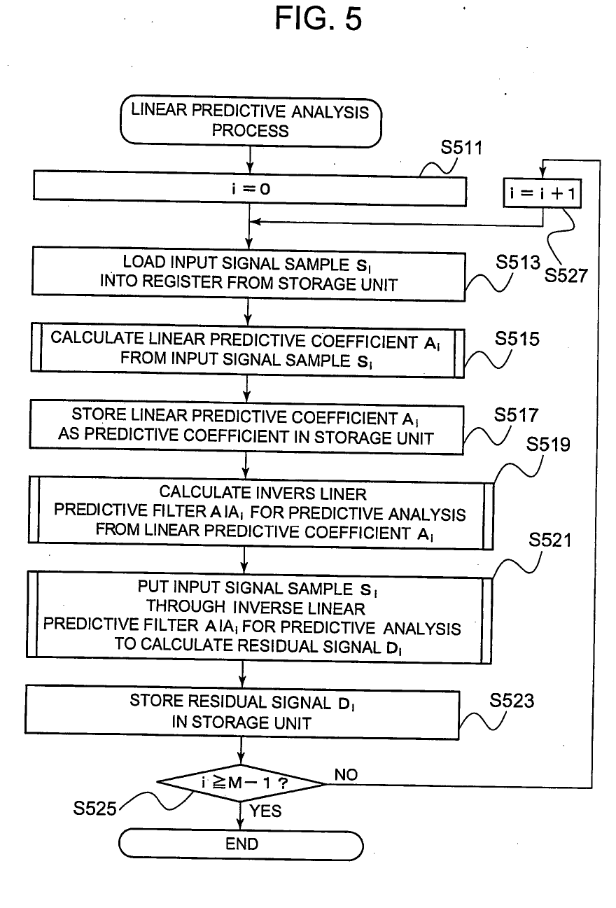

The predictive analyzer 131 performs a predictive analysis process on the digital speech signal supplied from the A/D converter 123. The predictive analysis in use is, for example, an MLSA (Mel Log Spectrum Approximation)-based predictive analysis or linear predictive analysis. Procedures of both analyses will be elaborated later referring to FIGS. 4 and 5.

In the predictive analysis, to be briefly speaking, the digital speech signal is subjected to time division, and a predictive coefficient and a residual signal in each time-divided time zone are calculated.

The length of a time zone for time-dividing a digital speech signal is preferably 5 ms, for example.

It is assumed hereinafter that a digital speech signal is time-divided to M time zones by the predictive analyzer 131. Given that the number of pieces of data (elements) of a digital speech signal included in each time zone is l (lower-case letter), the whole digital speech signal contains N (N=1×M) pieces of data.

The predictive analyzer 131 converts a digital speech signal Sᵢ={s_{i,0}, s_{i,1}, . . . , s_{i,l-1}} in a time zone i (i being an integer in the range of 0≦i≦M−1) to a predictive coefficient and a residual signal Dᵢ={d_{i,0}, d_{i,1}, . . . , d_{i,l-1}}. The predictive coefficient comprises a predetermined number of coefficients according to the analysis order.

More specifically, first the predictive analyzer 131 time-divides an input digital speech signal. Next, the predictive analyzer 131 calculates a predictive coefficient from the time-divided digital speech signal Sᵢ. Then, the predictive analysis inverse filter calculator 141 incorporated in the predictive analyzer 131 calculates a predictive analysis inverse filter from the predictive coefficient. Then, the predictive analyzer 131 inputs the digital speech signal Sᵢ to the predictive analysis inverse filter, and acquires an output from the predictive analysis inverse filter as a residual signal Dᵢ.

The predictive coefficient used in calculating the predictive analysis inverse filter is sent to the coder 125 from the predictive analyzer 131.

The residual signal is not directly sent to the coder 125 from the predictive analyzer 131 for coding the residual signal if directly sent to the coder 125 results in a vast amount of information.

Therefore, only a feature of the residual signal as intrinsic as possible is extracted to reduce the amount of information in advance before the residual signal is sent to the coder 125.

Specifically, the residual signal Dᵢ is divided into several bands by the band-pass filter unit 133. When the residual signal Dᵢ passes the first band-pass filter 151, a signal of a frequency component of band 1 is extracted from the residual signal Dᵢ. The signal extracted by the first band-pass filter 151 is called a band-1 residual signal. Likewise, a band-2 residual signal is extracted by the second band-pass filter 153. A band-3 residual signal is extracted by the third band-pass filter 155. Likewise, residual signals of band 4 and subsequent bands are extracted by the band-pass filter unit 133.

It is preferable that, for example, the residual signal Dᵢ should be divided into bands 1 to 6, with band 1 in a range of 0 to 1 kHz, band 2 in a range of 1 to 2 kHz, band 3 in a range of 2 to 3 kHz, band 4 in a range of 3 to 5 kHz, band 5 in a range of 5 to 6.5 kHz, and band 6 in a range of 6.5 to 8 kHz.

The residual signals of the individual bands extracted by the band-pass filter unit 133 are sent to both the gain calculation unit 135 and the voiced/unvoiced discrimination and pitch extraction unit 137.

The gain calculation unit 135 calculates the intensity of a residual signal for each band. The band-1 residual signal sent to the gain calculation unit 135 is input to the first gain calculator 161 in the gain calculation unit 135. Likewise, the band-2 residual signal and residual signals of the subsequent bands are respectively input to the second gain calculator 163 and the subsequent gain calculators.

A variable for identifying a band is expressed by ωRANGE. For example, a signal to be generated by the first band-pass filter 151 is a residual signal of the band with ω_{RANGE}=1. A signal to be generated by the second band-pass filter 153 is a residual signal of the band with ω_{RANGE}=2.

A residual signal of the band ω_{RANGE} in a time zone i is expressed by D(ω_{RANGE})ᵢ={d(ω_{RANGE})_{i,0}, d(ω_{RANGE})_{i,1}, . . . , dω_{RANGE})_{i,l-1}}.

The ω_{RANGE} gain calculator, such as the first gain calculator 161 or the second gain calculator 163, calculates G(ω_{RANGE})ᵢ, which is the gain of the band ωRANGE in the time zone i, from the input D(ω_{RANGE})ᵢ.

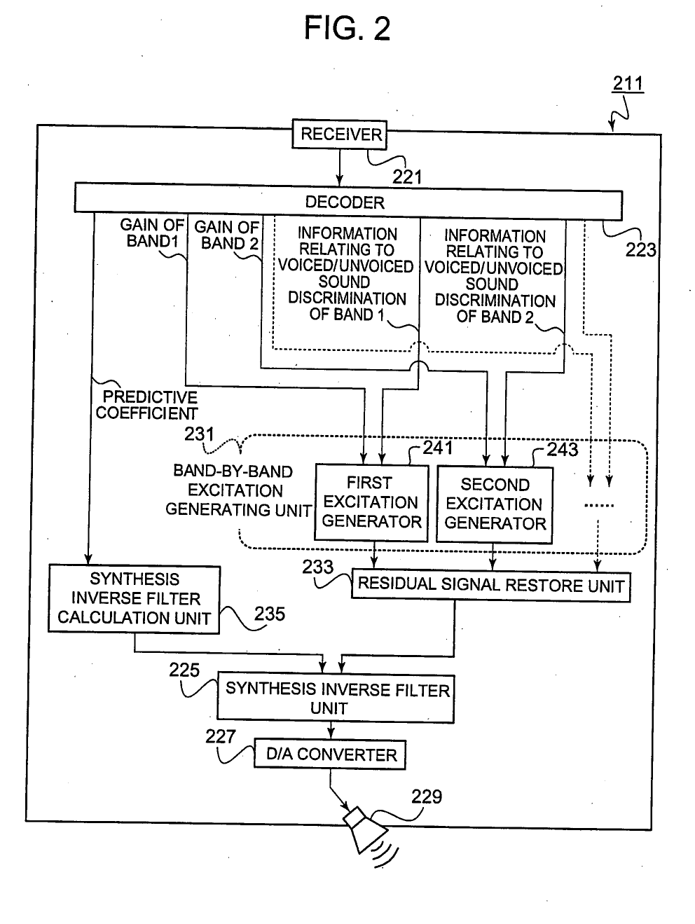

The gain G(ω_{RANGE})ᵢ represents the intensity (band-by-band residual signal intensity) of the component of the band ω_{RANGE} of the residual signal Dᵢ. In other words, the gain G(ω_{RANGE})ᵢ indicates the band dependency of the intensity of the residual signal Dᵢ in the band ω_{RANGE}. In a speech, generally speaking, for different bands, the components in the bands have different intensities. G(ω_{RANGE})ᵢ is used when a speech decoding apparatus 211 in FIG. 2 to be described later synthesizes a speech signal. Specifically, the speech decoding apparatus 211 synthesizes a speech signal reflecting the difference in intensity for each band by using the gain G(ω_{RANGE})ᵢ to reproduce the synthesized speech signal. As the speech coding apparatus 111 acquires the gain of the residual signal Dᵢ band by band, the speech decoding apparatus 211 can reproduce a high-quality speech signal as compared with a case where a speech signal is synthesized on the premise that the gain of the residual signal Dᵢ is a constant value not dependent on a band.

Various methods are available to calculate the gain G(ω_{RANGE})ᵢ. For example, the residual signal Dᵢ may be Fourier-transformed by FFT (Fast Fourier Transform) or the like so that the peak value or average value of the band ω_{RANGE} is the gain G(ω_{RANGE})ᵢ.

In the speech coding apparatus 111 according to the embodiment, the band-pass filter unit 133 calculates the residual signal D(ω_{RANGE})ᵢ of the band ω_{RANGE} as a numeral sequence {d(ω_{RANGE})_{i,0}, d(ω_{RANGE})_{i,1}, . . . , d(ω_{RANGE})_{i,l-1}} consisting of 1 elements (numerals). This eliminates the need for separate calculation of FFT or so. It is preferable to calculate the gain G(ω_{RANGE})ᵢ as follows, for example, using the numeral sequence.
G(ω_{RANGE})ᵢ=10×log₁₀[Avg{D(ω_{RANGE})ᵢ²}],
where Avg{D(ω_{RANGE})ᵢ²]={d(ω_{RANGE})_{i,0}²+d(ω_{RANGE})_{i,1}²+ . . . +d(ω_{RANGE})_{i,l-1}²}/1. That is, a mean square of a numeral sequence representing the residual signal D(ω_{RANGE})ᵢ of the band ω_{RANGE} in the time zone i is obtained, and then its logarithm is obtained to yield the gain G(ω_{RANGE})ᵢ.

The reason for obtaining the mean square is because the signal intensity can be acquired without depending on the positive/negative sign of each numeral in the numeral sequence {d(ω_{RANGE})_{i,0}, d(ω_{RANGE})_{i,1}, . . . , d(ω_{RANGE})_{i,l-1}}. The logarithm is obtained to take the relationship between the level of a sound and the audibility of a human into account.

The gain G(ω_{RANGE})ᵢ calculated is sent to the coder 125.

The residual signal of each band extracted by the band-pass filter unit 133 is also sent to the voiced/unvoiced discrimination and pitch extraction unit 137 in addition to the gain calculation unit 135.

The residual signal of band 1 sent to the voiced/unvoiced discrimination and pitch extraction unit 137 is input to a first voiced/unvoiced discriminator and pitch extractor 171 therein. Likewise, the residual signals of band 2 and subsequent bands are input to a second voiced/unvoiced discriminator and pitch extractor 173 and subsequent voiced/unvoiced discriminator and pitch extractors.

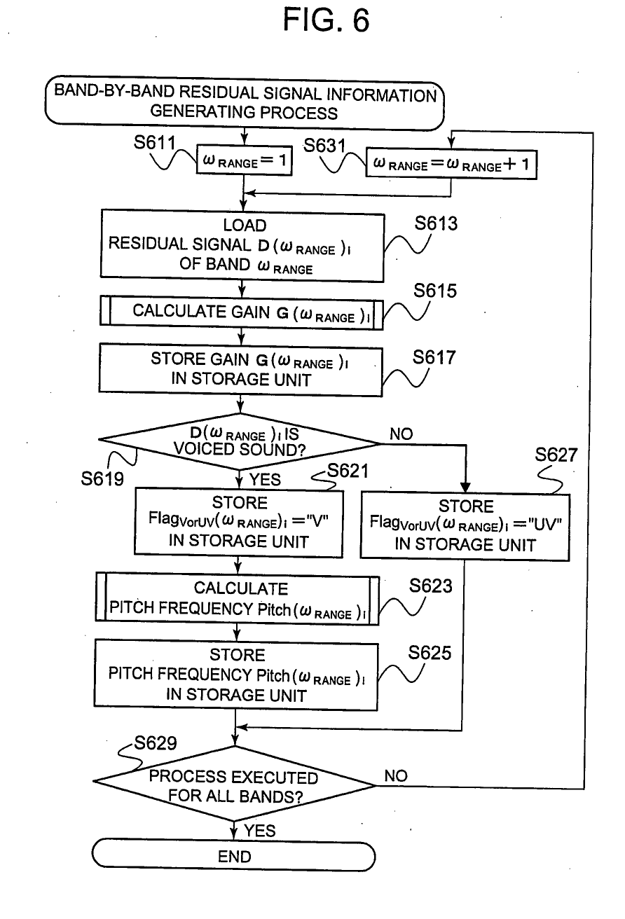

The processes that are executed by the ω_{RANGE} voiced/unvoiced discriminator and pitch extractor, such as the first voiced/unvoiced discriminator and pitch extractor 171 and second voiced/unvoiced discriminator and pitch extractor 173, will be explained in detail later referring to FIG. 6. Conclusion is that the ω_{RANGE} voiced/unvoiced discriminator and pitch extractor discriminates if the residual signal D(ω_{RANGE})ᵢ of the band ω_{RANGE} is a voiced sound or unvoiced sound, and sends the discrimination result to the coder 125. When the discrimination result is a voiced sound, the ω_{RANGE} voiced/unvoiced discriminator and pitch extractor sends the value of the pitch frequency to the coder 125 in addition to the discrimination result.

As apparent from the above, the coder 125 receives a predictive coefficient from the predictive analyzer 131, the gain of each band from the gain calculation unit 135, and the result of discrimination on a voiced/unvoiced sound of each band and the pitch frequency of each band whose residual signal has been discriminated to be a voiced sound from the voiced/unvoiced discrimination and pitch extraction unit 137.

After all, only the gain for each band, the result of discrimination on a voiced/unvoiced sound for each band, and the pitch frequency for each band whose residual signal has been discriminated to be a voiced sound are extracted from the residual signal and sent to the coder 125. In consideration of the property of a speech signal, those extracted pieces of information essentially characterize the property of a residual signal though small the amount of the information is. Hereinafter, the gain for each band, the result of discrimination on a voiced/unvoiced sound for each band, and the pitch frequency for each band whose residual signal has been discriminated to be a voiced sound are generically called “band-by-band residual signal information”.

As only a small amount of information which essentially characterizes the property of a residual signal is sent to the coder 125, the amount of information to be coded by the coder 125 can be made smaller than that in a case where the entire residual signal is sent to the coder 125. Therefore, the speech coding apparatus 111 according to the present invention can compress a speech to the level on which the low-bit rate speech compression technique is premised.

The gain, the result of discrimination on a voiced/unvoiced sound, and the pitch frequency, which are information that varies band by band, are used in reproducing a speech in the speech decoding apparatus 211 in FIG. 2. Therefore, the quality of a speech to be reproduced in the speech decoding apparatus 211 is improved as compared with a case where a band-by-band feature is not extracted from the residual signal Dᵢ.

The coder 125 receives a predictive coefficient and band-by-band residual signal information indicating the band-by-band feature of the residual signal, and codes them. Then, the predictive coefficient coded and band-by-band residual signal information coded are sent to the transmitter 127. Hereinafter the predictive coefficient that is coded is called “coded predictive coefficient”, and the band-by-band residual signal information that is coded is called “coded band-by-band residual signal information”.

The coder that codes a predictive coefficient, and the coder that codes band-by-band residual signal information may be provided separately. In this case, a coded predictive coefficient and coded band-by-band residual signal information are sent to the transmitter 127 from the respective coders.

The coder 125 codes information using an arbitrary known coding method. There are various coding methods known, and there are various information compression rates. Even with the same coding method in use, the compression rate may vary depending on the property of a signal to be coded. It is desirable that the speech coding apparatus 111 according to the embodiment should employ a coding method that can compress a predictive coefficient and band-by-band residual signal information to the maximum level. Which coding method is suitable does not matter.

For the speech coding apparatus 111 in FIG. 1 to sequentially transmit information in individual time zones and for the speech decoding apparatus 211 in FIG. 2 to reproduce speeches from the information substantially in real time, it is desirable to employ the coding method that ensures easy prediction of the amount of signals after compression and make the signal amount substantially the same over every time zone. This is because it is easy to design the speech analysis process and the subsequent transmission process, and the reception process and the subsequent speech synthesis process in consideration of the restrictions on the performance of the apparatuses.

The transmitter 127 in FIG. 1 receives a coded predictive coefficient and coded band-by-band residual signal information from the coder 125, and sends them to the speech decoding apparatus 211 in FIG. 2. The transmission is carried out wirelessly in the embodiment. However, other various transmission methods, such as cable transmission and a combination of cable transmission and wireless transmission, may be employed as well.

FIG. 2 is a functional configuration diagram of the speech decoding apparatus 211 according to the embodiment. The speech decoding apparatus 211 reflects the intensity of a band-by-band residual signal on a speech signal to be restored.

As shown in FIG. 2, the speech decoding apparatus 211 includes a receiver 221, a decoder 223, a band-by-band excitation generating unit 231, a synthesis inverse filter calculation unit 235, a residual signal restore unit 233, a synthesis inverse filter unit 225, a D/A converter 227, and a speaker 229.

The band-by-band excitation generating unit 231 has a first excitation generator 241, a second excitation generator 243, and necessary excitation generators (not shown) following the second excitation generator 423.

The receiver 221 receives a coded predictive coefficient and a coded band-by-band residual signal information from the transmitter 127 of the speech coding apparatus 111 in FIG. 1, and supplies them to the decoder 223.

The decoder 223 decodes the coded predictive coefficient and coded band-by-band residual signal information supplied from the receiver 221 to generate a predictive coefficient and band-by-band residual signal information in each time zone. Specifically, in each time zone, the decoder 223 generates a predictive coefficient, a band-by-band gain of a residual signal, the result of a voiced/unvoiced sound discrimination of a residual signal for each band, and the pitch frequency for each band whose residual signal has been discriminated to be a voiced sound.

The decoded band-by-band residual signal information is sent to the band-by-band excitation generating unit 231. At this time, two kinds of information, gain information and information relating to voiced/unvoiced sound discrimination (the result of a voiced/unvoiced sound discrimination and the pitch frequency when the residual signal is a voiced sound), are gathered band by band.

That is, the gain of band 1 and information relating to voiced/unvoiced sound discrimination of band 1 are gathered and input to the first excitation generator 241. Likewise, the gain of band 2 and information relating to voiced/unvoiced sound discrimination of band 2 are gathered and input to the second excitation generator 243. A similar process is carried out for those two kinds of information of band 3 and subsequent bands.

The first excitation generator 241 generates a pulse sequence or a noise sequence of band 1, and sends the pulse sequence or noise sequence to the residual signal restore unit 233. The second excitation generator 243 generates a pulse sequence or a noise sequence of band 2, and sends the pulse sequence or noise sequence to the residual signal restore unit 233. A similar process is carried out for the third excitation generator and subsequent excitation generators.

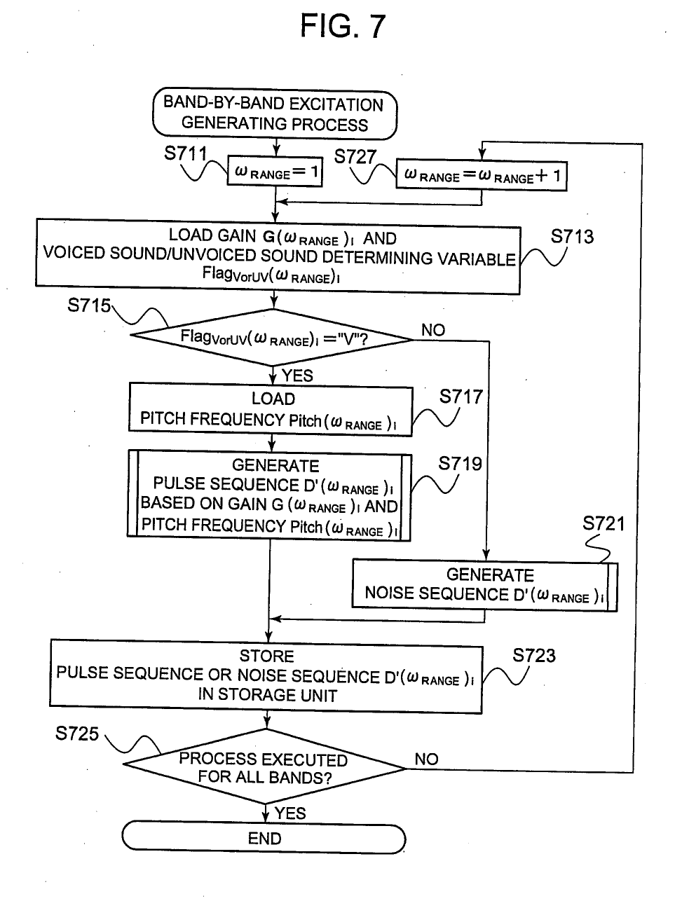

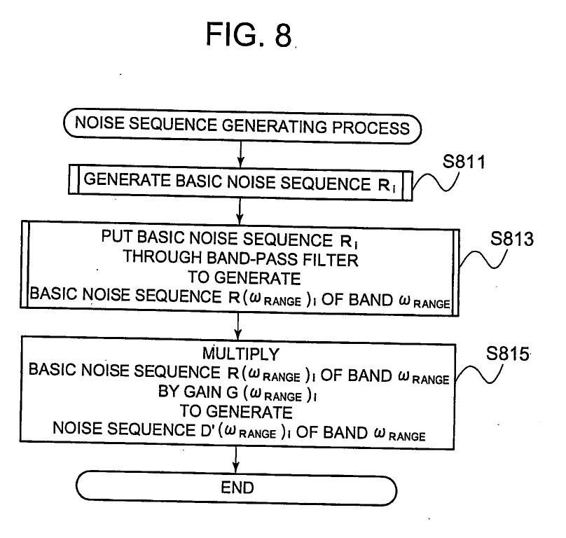

That is, the band-by-band excitation generating unit 231 generates a pulse sequence or noise sequence-as an excitation signal of each band, and sends it to the residual signal restore unit 233. The procedures of generating a pulse sequence or noise sequence of each band will be elaborated later referring to FIGS. 7 and 8. The following is the brief description of the procedures. For example, upon reception of the discrimination result indicating that the residual signal of band 1 is a voiced sound, and the pitch frequency, the first excitation generator 241 generates a pulse sequence which has the pitch frequency and whose level becomes the gain of band 1. Upon reception of the discrimination result indicating that the residual signal of band 1 is an unvoiced sound, on the other hand, the first excitation generator 241 extracts a component of band 1 from a previously prepared pulse sequence which has a level 1 having a random time interval, and multiplies the component by the gain of band 1 to generate a noise sequence.

In this manner, the band-by-band excitation generating unit 231 generates, for each band, a pulse sequence or noise sequence which is a band-by-band excitation signal having a band dependency indicated by the band-by-band gain.

The residual signal restore unit 233 is an adder which adds together pulse sequences or noise sequences of individual bands supplied from the band-by-band excitation generating unit 231. The process on band-by-band residual signal information which is executed by the speech decoding apparatus 211 is nearly reverse to the process on a residual signal which is executed by the speech coding apparatus 111 in FIG. 1. Accordingly, adding the pulse sequences or noise sequences generated by the band-by-band excitation generating unit 231 restores a residual signal.

It is to be noted however that, as mentioned above, band-by-band residual signal information sent to the speech decoding apparatus 211 in FIG. 2 from the speech coding apparatus 111 in FIG. 1 is information indicating the essential property of a residual signal Dᵢ, not the residual signal Dᵢ itself. Because there is information which is cut off by the sender or the speech coding apparatus 111, the residual signal restore unit 233 cannot restore the original residual signal Dᵢ completely. Strictly speaking, the residual signal restore unit 233 does not restore the residual signal Dᵢ completely, but generates a signal approximate to the residual signal Dᵢ making the best use of the acquired information. That is, the residual signal restore unit 233 does not restore a residual signal Dᵢ={d_{i,0}, d_{i,1}, . . . , d_{i,l-1}}, but generates a pseudo residual signal D′ᵢ={d′_{i,0}, d′_{i,1}, . . . , d′_{i,1-1}}. As mentioned earlier, the essential feature of a speech extracted by the speech coding apparatus 111 in FIG. 1 is transmitted to the speech decoding apparatus 211 in FIG. 2 which generates a pseudo residual signal D′ᵢ based on the feature. Therefore, the pseudo residual signal D′ᵢ is a good approximation of the residual signal Dᵢ and is suitable as an excitation signal (signal for excitation) for reproducing a speech.

As has been described already, a residual signal and an excitation signal are merely the same signal seen from different viewpoints.

The predictive coefficient decoded by the decoder 223 is sent to the synthesis inverse filter calculation unit 235. The synthesis inverse filter calculation unit 235 calculates an inverse filter for speech synthesis using the predictive coefficient. An arbitrary known scheme can be used for the calculation of the inverse filter. The “inverse filter for speech synthesis” is a filter having a property such that a speech signal is synthesized by inputting an excitation signal to the filter.

The result of the calculation of the inverse filter by the synthesis inverse filter calculation unit 235 is sent to the synthesis inverse filter unit 225. The synthesis inverse filter unit 225 determines the specifications of the inverse filter for speech synthesis according to the received result of the calculation of the inverse filter. It may be construed that the synthesis inverse filter calculation unit 235 generates the synthesis inverse filter unit 225.

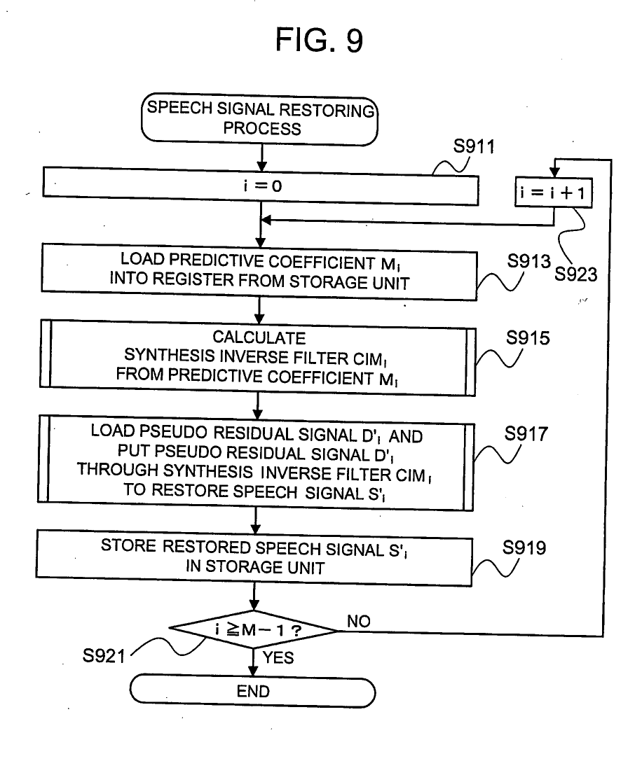

A digital speech signal is restored by inputting the pseudo residual signal D′ᵢ as an excitation signal to the synthesis inverse filter unit 225. The above-described procedures of restoring a speech signal will be elaborated later referring to FIG. 9.

The speech decoding apparatus 211 receives all the information on a predictive coefficient. Unless a reduction in the amount of information which is caused in the coding and decoding processes, therefore, the synthesis inverse filter unit 225 can completely restore the original inverse filter. As mentioned above, the signal that is input as an excitation signal to the synthesis inverse filter unit 225 is the pseudo residual signal D′ᵢ. Therefore, a digital speech signal which is synthesized through the inverse filter by the synthesis inverse filter unit 225 is not the high fidelity of the original digital speech signal Sᵢ.

However, the information which is extracted based on the property of a speech signal and indicates the essential feature of a residual signal is transmitted to the speech decoding apparatus 211. A pseudo residual signal is then generated using the information. Therefore, the output of the synthesis inverse filter unit 225 obtained as a result of inputting the pseudo residual signal as an excitation signal to the synthesis inverse filter unit 225 is an approximate signal of the original speech signal Sᵢ.

The reproduction signal output from the synthesis inverse filter unit 225 is converted to an analog speech signal by the D/A converter 227. The analog speech signal is sent to the speaker 229. The speaker 229 generates a speech according to the received analog speech signal.

While information to be transmitted from the speech coding apparatus to the speech decoding apparatus has a less amount, the information, if having an insufficient consideration on the property of a signal to be transmitted, cannot sufficiently enhance the quality of a reproduced speech. The speech coding apparatus 111 and the speech decoding apparatus 211 according to the embodiment are so designed that a speech having as high a quality as possible can be reproduced even in the situation where the amount of information which can be transmitted to the speech decoding apparatus 211 from the speech coding apparatus 111 is limited. In this respect, the present inventor examined how to allow information to be transmitted to sufficiently hold the property of a speech signal while reducing the amount of information to be transmitted as much as possible. As a result of the examination, paying attention to the fact that a signal to be transmitted is a speech signal and in consideration of the property thereof, the present inventor decided to reflect the difference between band-by-band properties of residual signals acquired by predictive analysis on speech reproduction. Specifically, the apparatus that sends a speech signal extracts the intensity of a residual signal for each band, and the apparatus that receives the speech signal reflects the band-by-band intensity of a residual signal on speech reproduction. Because the band-by-band property of a residual signal can be represented by a slight amount of information, it leads to a significant improvement on the quality of a reproduced speech.

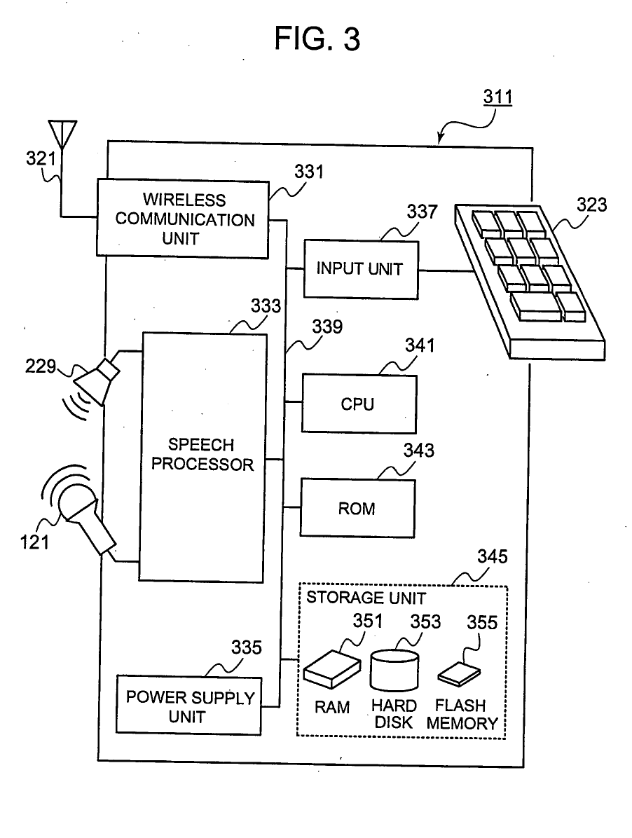

The speech coding apparatus 111 and the speech decoding apparatus 211 which have been explained referring to FIGS. 1 and 2 are realized by a speech coding/decoding apparatus 311 in FIG. 3 which has the functions of the physically combined from the viewpoint of better usability. That is, the speech coding/decoding apparatus 311, like the speech coding apparatus 111, can code a speech signal input from a microphone and send the coded data. Like the speech decoding apparatus 211, the speech coding/decoding apparatus 311 can receive coded data, decode the coded data and output the decoded speech signal through a speaker. The speech coding/decoding apparatus 311 is assumed to be a cellular phone, for example.

As shown in FIG. 3, the speech coding/decoding apparatus 311 has a microphone 121 shown in FIG. 1 and a speaker 229 shown in FIG. 2.

The speech coding/decoding apparatus 311 further has an antenna 321, an operation key 323, a wireless communication unit 331, a speech processor 333, a power supply unit 335, an input unit 337, a CPU 341, a ROM (Read Only Memory) 343, and a storage unit 345. The wireless communication unit 331, the speech processor 333, the power supply unit 335, the input unit 337, the CPU 341, the ROM 343 and the storage unit 345 are mutually connected by a system bus 339. The system bus 339 is a transfer path for transferring commands and data.

An operational program for coding and decoding a speech is stored in the ROM 343.

The functions of the predictive analyzer 131, the band-pass filter unit 133, the gain calculation unit 135, the voiced/unvoiced discrimination and pitch extraction unit 137, and the coder 125 in FIG. 1 are realized by numerical processes executed by the CPU 341. The functions of the decoder 223, the band-by-band excitation generating unit 231, the residual signal restore unit 233, the synthesis inverse filter calculation unit 235, and the synthesis inverse filter unit 225 in FIG. 2 are realized by numerical processes executed by the CPU 341. The A/D converter 123 in FIG. 1 and the D/A converter 227 in FIG. 2 are included in the speech processor 333. The transmitter 127 in FIG. 1 and the receiver 221 in FIG. 2 are included in the wireless communication unit 331.

The operational program stored in the ROM 343 includes programs for the aforementioned numerical processes executed by the CPU 341.

In addition to the operational program, an operating system needed for the general control of the speech coding/decoding apparatus 311 is stored in the ROM 343.

The CPU 341 codes or decodes a speech by executing the operational program and the operating system stored in the ROM 343.

The CPU 341 executes numerical operations according to the operational program stored in the ROM 343. The storage unit 345 stores a numeral sequence to be processed, e.g., a digital speech signal Sᵢ, and stores a numeral sequence as a process result, e.g., a residual signal Dᵢ.

The storage unit 345 comprises one of or some combination of a RAM (Random Access Memory) 351, a hard disk 353, a flash memory 355. Specifically, the storage unit 345 stores, a digital speech signal, a predictive coefficient, a residual signal, a band-by-band residual signal, a band-by-band gain, the result of a voiced/unvoiced sound discrimination for each band, the pitch frequency for each band whose residual signal has been discriminated to be a voiced sound, a coded predictive coefficient, coded band-by-band residual signal information, a pulse sequence or noise sequence generated band by band, the result of calculating an inverse filter, a pseudo residual signal, etc.

The CPU 341 incorporates a register (not shown). The CPU 341 loads a numeral sequence to be processed into the register from the storage unit 345, as needed, according to the operational program read from the ROM 343. The CPU 341 performs a predetermined operational process on the numeral sequence loaded into the register, and stores a numeral sequence resulting from the process into the storage unit 345.

The RAM 351 and the hard disk 353 in the storage unit 345 store a numeral sequence to be processed in a shared manner or at the same time in consideration of their access speeds and memory capacities. The flash memory 355 is a removable medium. Data stored in the RAM 351 or the hard disk 353 is copied into the flash memory 355 as needed. The flash memory 355 storing copied data may be unloaded from the speech coding/decoding apparatus 311, and to be used by another device, such as a personal computer, so that the device can use the data.

When the speech coding/decoding apparatus 311 serves as the speech coding apparatus 111 (FIG. 1), the wireless communication unit 331 and the speech processor 333 function as follows. First, a speech input to the microphone 121 is converted to a digital speech signal by the A/D converter 123 (FIG. 1) in the speech processor 333. The digital speech signal is coded by the function of the speech coding apparatus 111 shown in FIG. 1 which is realized by the CPU 341, the ROM 343 and the storage unit 345. Then, the transmitter 127 (FIG. 1) in the wireless communication unit 331 sends a coded predictive coefficient and coded band-by-band residual signal information to the counter part (another speech coding/decoding apparatus 311 on the receiving side) using the antenna 321.

When the speech coding/decoding apparatus 311 serves as the speech decoding apparatus 211 (FIG. 2), the wireless communication unit 331 and the speech processor 333 function as follows. First, the receiver 221 (FIG. 2) in the wireless communication unit 331 receives the coded predictive coefficient and coded band-by-band residual signal information using the antenna 321. The coded data received is decoded into a digital speech signal by the function of the speech decoding apparatus 211 shown in FIG. 2 which is realized by the CPU 341, the ROM 343 and the storage unit 345. The digital speech signal is converted to an analog speech signal by the D/A converter 227 (FIG. 2) in the speech processor 333. The analog speech signal is output as a speech from the speaker 229.

The input unit 337 receives an operation signal from the operation key 323 and inputs a key code signal corresponding to the operation signal to the CPU.341. The CPU 341 determines the operation content based on the input key code signal.

For example, information, such as the number of bands to which a speech is divided and sizes of the individual bands, is preset in the ROM 343. However, a user if desirable can change the setting himself or herself using the operation key 323 and the input unit 337. Specifically, the user can change the setting by inputting a frequency value or the like using the operation key 323. The user can also input a predetermined operational command for power ON/OFF, for example, using the operation key 323.

The power supply unit 335 is the power supply for driving the speech coding/decoding apparatus 311.

MLSA-Based Predictive Analysis Process

MLSA-based predictive analysis as one example of the predictive analysis that is executed by the predictive analyzer 131 in FIG. 1 will be explained below referring a flowchart illustrated in FIG. 4. As has already been described, the function of the predictive analyzer 131 is realized by the CPU 341 (FIG. 3).

It is assumed that prior to the initiation of the predictive analysis process, an input signal sample Sᵢ={s_{i,0}, s_{i,1}, . . . , s_{i,l-1}} (i being an integer in the range of 0≦i≦M−1) which is a digital speech signal indicating the input waveform of a speech is stored in the storage unit 345 (FIG. 3).

The CPU 341 uses a built-in counter register (not shown) as an input signal sample counter which counts a value i. When the predictive analysis process starts, the CPU 341 sets the value i of the input signal sample counter to the initial value of i=0 (step S411 in FIG. 4).

The CPU 341 loads the input signal sample Sᵢ={s_{i,0}, s_{i,1}, . . . , s_{i,l-1}} according to the value i of the input signal sample counter into a built-in general-purpose register (not shown) from the storage unit 345 (step S413). When the input signal sample counter is set to i=0, for example, an input signal sample S₀={s_{0,0}, s_{0,1}, . . . , s_{0,l-1}} is loaded.

Next, the CPU 341 calculates a cepstrum Cᵢ={c_{i,0}, c_{i,1}, . . . , c_{i,2-1})} from the loaded input signal sample Sᵢ={s_{i,0}, s_{i,1}, . . . , s_{i,l-1}} (step S415). The cepstrum may be acquired by using an arbitrary known scheme. To acquire the cepstrum, it is generally essential to take procedures, such as performing discrete Fourier transform, obtaining an absolute value, obtaining a logarithm and performing inverse discrete Fourier transform.

Then, the CPU 341 calculates an MLSA filter coefficient Mᵢ={m_{i,0}, m_{i,1}, . . . , m_{i,p-1}} from the acquired cepstrum Cᵢ={c_{i,0}, c_{i,1}, . . . , c_{i,1/2-1}} where p is the order of MLSA-based predictive analysis (step S417). The MLSA filter coefficient may be acquired by using an arbitrary known scheme.

Then, the CPU 341 stores the MLSA filter coefficient Mᵢ={m_{i,0}, m_{i,1}, . . . , m_{i,p-1}} as a predictive coefficient in the storage unit 345 (step S419).

Further, the CPU 341 calculates an inverse MLSA filter AIMᵢ for predictive analysis from the MLSA filter coefficient Mᵢ={m_{i,0}, m_{i,1}, . . . , m_{i,p-1}} (step S421). It can be said that the process of step S421 is executed by the predictive analysis inverse filter calculator 141 shown in FIG. 1. The inverse MLSA filter for predictive analysis may be acquired by using an arbitrary known scheme.

The CPU 341 puts the input signal sample Sᵢ={s_{i,0}, s_{i,1}, . . . , s_{i,l-1}} through the acquired inverse MLSA filter AIMᵢ for predictive analysis to calculate a residual signal Dᵢ={d_{i,0}, d_{i,1}, . . . , d_{i,l-1}} (step S423). The CPU 341 stores the acquired residual signal Dᵢ in the storage unit 345 (step S425).

Through the processes of the steps S413 to S425, when the input signal sample counter is set to i=0, for example, an MLSA filter coefficient M₀={m_{0,0}, m_{0,1}, . . . , m_{0,p-1}} and a residual signal D₀={d_{0,0}, d_{0,1}, . . . , d_{0,l-1}} are stored in the storage unit 345.

The CPU 341 determines if the value i of the input signal sample counter has reached M−1 (step S427). When i≧M−1 (step S427: Yes), the CPU 341 terminates the MLSA-based predictive analysis process. When i<M−1 (step S427: No), on the other hand, the CPU 341 increments i by 1 (step S429) and repeats the processes of steps S413 to S427 to process an input signal sample in a next time zone.

Linear Predictive Analysis Process

Linear predictive analysis as one example of the predictive analysis that is executed by the predictive analyzer 131 in FIG. 1 will be explained below referring a flowchart illustrated in FIG. 5. As has already been described, the function of the predictive analyzer 131 is realized by the CPU 341 (FIG. 3).

It is assumed that prior to the initiation of the predictive analysis process, an input signal sample Sᵢ={s_{i,0}, s_{i,1}, . . . , s_{i,l-1}} (i being an integer in the range of 0≦i≦M−1) which is a digital speech signal indicating the input waveform of a speech is stored in the storage unit 345 (FIG. 3).

The CPU 341 uses the built-in counter register (not shown) as an input signal sample counter which counts a value i. When the predictive analysis process starts, the CPU 341 sets the value i of the input signal sample counter to the initial value of i=0 (step S511 in FIG. 5).

The CPU 341 loads the input signal sample Sᵢ={s_{i,0}, s_{i,1}, . . . , s_{i,l-1}} according to the value i of the input signal sample counter into the built-in general-purpose register (not shown) from the storage unit 345 (step S513). When the input signal sample counter is set to i=0, for example, an input signal sample S₀={s_{0,0}, s_{0,1}, . . . , s_{0,1-1}} is loaded.

Next, the CPU 341 calculates a linear predictive coefficient Aᵢ={a_{i,1}, a_{i,2}, . . . , a_{i,n}} from the loaded input signal sample Sᵢ={s_{i,0}, s_{i,1}, . . . , s_{i,l-1}} where n is the order of linear predictive analysis (step S515). The linear predictive coefficient may be calculated by using an arbitrary known method as long as a residual signal is evaluated as sufficiently small based on a predetermined scale in the calculation method. For example, it is suitable to employ a known calculation method which combines calculation of an auto correlation function and the Levinson-Durbin algorithm.

Then, the CPU 341 stores the linear predictive coefficient Aᵢ={a_{i,1}, a_{i,2}, . . . , a_{i,n}} as a predictive coefficient in the storage unit 345 (step S517).

Further, the CPU 341 calculates an inverse linear predictive filter AIAᵢ for predictive analysis from the linear predictive coefficient Aᵢ={a_{i,1}, a_{i,2}, . . . , a_{i,n}} (step S519). It can be said that the process of step S519 is executed by the predictive analysis inverse filter calculator 141 shown in FIG. 1. The inverse linear predictive filter for predictive analysis may be acquired by using an arbitrary known scheme.

The CPU 341 puts the input signal sample Sᵢ={s_{i,0}, s_{i,1}, . . . , s_{s,l-1}} through the acquired inverse linear predictive filter AIAᵢ for predictive analysis to calculate a residual signal Dᵢ={d_{i,0}, d_{i,1}, . . . , d_{i,l-1}} (step S521). The CPU 341 stores the acquired residual signal Dᵢ in the storage unit 345 (step S523).

Through the processes of the steps S513 to S523, when the input signal sample counter is set to i=0, for example, a linear predictive coefficient A₀={a_{0,1}, a_{0,2}, . . . , a_{0,n}} and a residual signal D₀={d_{0,0}, d_{0,1}, . . . , d_{0,l-1}} are stored in the storage unit 345.

The CPU 341 determines if the value i of the input signal sample counter has reached M−1 (step S525). When i≧M−1 (step S525: Yes), the CPU 341 terminates the linear predictive analysis process. When i<M−1 (step S525: No), on the other hand, the CPU 341 increments i by 1 (step S527) and repeats the processes of steps S513 to S525 to process an input signal sample in a next time zone.

Band-by-band Residual Signal Information Generating Process

A band-by-band residual signal information generating process that is executed by the gain calculation unit 135 and the voiced/unvoiced discrimination and pitch extraction unit 137 in FIG. 1 will be explained below referring a flowchart illustrated in FIG. 6. As has already been described, the functions of the gain calculation unit 135 and the voiced/unvoiced discrimination and pitch extraction unit 137 are realized by the CPU 341 (FIG. 3).

The following is the description of the band-by-band residual signal information generating process in a time zone i.

It is assumed that a band-by-band residual signal D(ωRANGE)i which is generated as a residual signal Dᵢ is input to the band-pass filter unit 133 (FIG. 1) has already been stored in the storage unit 345 (FIG. 3).

The CPU 341 uses the built-in counter register (not shown) to store a band identification variable ω_{RANGE}. When the band-by-band residual signal information generating process starts, the CPU 341 sets the band identification variable ω_{RANGE} to the initial value of ω_{RANGE}=1 (step S611 in FIG. 6).

The CPU 341 loads a residual signal D(ω_{RANGE})ᵢ={d(ω_{RANGE})_{i,0}, d(ω_{RANGE})_{i,1}, . . . , d(ω_{RANGE})_{i,l-1}} of band ω_{RANGE} into the built-in general-purpose register (not shown) from the storage unit 345 (step S613). When ω_{RANGE}=1 is set, for example, a residual signal D(1)ᵢ={d(1)_{i,0}, d(1)_{i,1}, . . . , d(1)_{i,l-1}} of band 1 is loaded.

Next, the CPU 341 calculates a gain G(ω_{RANGE})ᵢ from the loaded residual signal D(ω_{RANGE})ᵢ (step S615). As has been described above, the following is the calculation method for the gain G(ω_{RANGE})ᵢ.
G(ω_{RANGE})ᵢ=10×log₁₀[Avg{D(ω_{RANGE})ᵢ²}],
where Avg{D(ω_{RANGE})ᵢ²}]={d(ω_{RANGE})_{i,0}²+d(ω_{RANGE})_{i,1}²+ . . . +d(ω_{RANGE})_{i,l-1}²}/1.

The CPU 341 stores the calculated gain G(ω_{RANGE})ᵢ in the storage unit 345 (step S617).

Next, the CPU 341 discriminates whether the residual signal D(ω_{RANGE})ᵢ is a voiced sound (step S619).

Whether or not the residual signal D(ω_{RANGE})ᵢ is a voiced sound is whether or not the residual signal D(ω_{RANGE})ᵢ has a property as a pitch. When the residual signal D(ω_{RANGE})ᵢ has a periodicity, the residual signal D(ω_{RANGE})ᵢ can be said to have a property as a pitch. Accordingly, it is checked if the residual signal D(ω_{RANGE})ᵢ has periodicity.

An arbitrary known scheme may be used to check if the residual signal D(ω_{RANGE})ᵢ has periodicity. For example, it is suitable to acquire a standardized auto correlation function from the residual signal and check if the function has a sufficiently large extreme value (local maximal value). If such a maximal value is present, it can be said that the residual signal has periodicity. It is also said that the time interval which provides such a maximal value is the period of the residual signal. If such a maximal value is not present, it can be said that the residual signal does not have periodicity.

An auto correlation function C(t) of the residual signal D(ω_{RANGE})ᵢ is given by:

$$\begin{matrix}C ( t ) = {d ( {ω}_{RANGE} )}_{i , 0} ⨯ {d ( {ω}_{RANGE} )}_{i , t} + \\ d {( {ω}_{RANGE} )}_{i , 1} ⨯ {d ( {ω}_{RANGE} )}_{i , t + 1} + … + \\ {d ( {ω}_{RANGE} )}_{i , 1 - 1 - t} ⨯ {d ( {ω}_{RANGE} )}_{i , 1 - 1}\end{matrix}$$

where t is the number of elements included in the residual signal D(ω_{RANGE})ᵢ as a unit. That is, the variable t takes an integer from 0 to (l−1). Strictly speaking, therefore, t times the time interval in which each element included in the residual signal D(ω_{RANGE})ᵢ is sampled is the time. To acquire the pitch frequency, therefore, it is necessary to convert t to a time. Because the time interval in which each element included in the residual signal D(ω_{RANGE})ᵢ is sampled is constant in the embodiment, the time is proportional to t.

In principle, the presence/absence of a maximal value is found out by using the auto correlation function C(t). It is however necessary to remove an accidental maximal value which can frequently occur in numeral calculation. Accordingly, the presence of periodicity is predicted from the presence of a maximal value exceeding a predetermined threshold value Cₜₕ. It is apparent from the equation given above that C(t) is proportional to the square of the order of the size of each element in the residual signal D(ω_{RANGE})ᵢ. As the value of each element in the residual signal D(ω_{RANGE})ᵢ increases, therefore, the auto correlation function C(t) becomes larger. Then, the threshold value Cₜₕ should be changed adequately according to the level of the residual signal D(ω_{RANGE})ᵢ. In this respect, the threshold value Cₜₕ is set constant and the auto correlation function C(t) is standardized.

Any method can be employed to standardize the auto correlation function C(t) as long as the size of the auto correlation function C(t) does not depend on the level of the residual signal D(ω_{RANGE})ᵢ. For example, it is suitable to define a standardizing factor REG(t) and a standardizing auto correlation function C_{REG}(t) as follows.
REG(t)=[{d(ω_{RANGE})_{i,0}²+d(ω_{RANGE})_{i,1}²+ . . . +d(ω_{RANG})_{i,l-1-5}²}×{d(ω_{RANGE})_{i,t}²+d(ω_{RANGE})_{i,t+1}²+ . . . +d(ω_{RANGE})_{i,l-1}²}]^{0.5}.

C_{REG}(t)=C(t)/REG(t).

The threshold value Cₜₕ can be any value as long as the value is helpful in determining if a clear maximal value is present in the standardizing auto correlation function C_{REG}(t). As C_{REG}(t=0) is always 1, it is suitable to set the threshold value Cₜₕ to, for example, a half of 1 or 0.5.

In step S619, the CPU 341 calculates the standardizing auto correlation function C_{REG}(t) from the residual signal D(ω_{RANGE})ᵢ, and determines whether a maximal value C_{REG}(t=t_{MAX}) which is C_{REG}(t=t_{MAX})>Cₜₕ(=0.5) is present in the standardizing auto correlation function C_{REG}(t).

When a maximal value is present in the standardizing auto correlation function C_{REG}(t), i.e., when the residual signal D(ω_{RANGE})ᵢ has a property as a voiced sound (step S619: Yes), the CPU 341 sets a voiced sound/unvoiced sound determining variable Flag_{VorUV}(ω_{RANGE})ᵢ which is a variable representing a voiced sound or unvoiced sound to Flag_{VorUV}(ω_{RANGE})ᵢ=“V”, and is stored in the storage unit 345 (step S621). Further, the CPU 341 obtains the reciprocal of t_{MAX} which is the value of t at which the value of the standardizing auto correlation function C_{REG}(t) becomes maximal to calculate a pitch frequency Pitch(ω_{RANGE})ᵢ (step S623). The CPU 341 stores the calculated pitch frequency Pitch(ω_{RANGE})ᵢ in the storage unit 345 (step S625), and then proceeds the process to step S629.

When the maximal value C_{REG}(t)>Cₜₕ(=0.5) is not present in the standardizing auto correlation function C_{REG}(t) (step S619: No), the CPU 341 sets the voiced sound/unvoiced sound determining variable Flag_{V}_{ₒᵣ}_{UV}(ω_{RANGE})ᵢ to Flag_{V}_{ₒᵣ}_{UV}(ω_{RANGE})ᵢ=“UV”, and is stored in the storage unit 345 (step S627). Then, the CPU 341 proceeds the process to step S629.

Through the processes of the steps S613 to S627, when ω_{RANGE}=1 is set, for example, the gain G(1)ᵢ of band 1 and Flag_{VorUV}(1)ᵢ of band 1 are stored in the storage unit 345. When Flag_{VorUV}(1)ᵢ=“V”, the pitch frequency Pitch(1)ᵢ of band 1 is stored in the storage unit 345 in addition to the gain G(1)ᵢ of band 1 and Flag_{VorUV}(1)ᵢ of band 1.

In step S629, the CPU 341 discriminates whether the processes of S613 to S627 have been executed for all the bands. When the processes have been executed for all the bands (step S629: Yes), the CPU 341 terminates the band-by-band residual signal information generating process. When the processes have not been executed for all the bands yet (step S629: No), the CPU 341 increments the band identification variable ω_{RANGE} by 1 (step S631) and repeats the processes of steps S613 to S629 to process a residual signal of a next band.

Gain calculation, voiced/unvoiced sound discrimination and pitch extraction in case of a voiced sound are carried out for each band of the residual signal in this manner.

Band-by-band Excitation Generating Process

A band-by-band excitation generating process that is executed by the band-by-band excitation generating unit 231 in FIG. 2 will be explained below referring a flowchart illustrated in FIG. 7. As has already been described, the function of the band-by-band excitation generating unit 231 is realized by the CPU 341 (FIG. 3).

The following is the description of the band-by-band excitation generating process in a time zone i.

It is assumed that the gain G(ω_{RANGE})ᵢ, the voiced sound/unvoiced sound determining variable Flag_{VorUV}(ω_{RANGE})ᵢ, and the pitch frequency Pitch(ω_{RANGE})ᵢ decoded by the decoder 223 for each band have already been stored in the storage unit 345 (FIG. 3).

The CPU 341 uses the built-in counter register (not shown) to store the band identification variable ω_{RANGE}. When the band-by-band excitation generating process starts, the CPU 341 sets the band identification variable ω_{RANGE} to the initial value of ω_{RANGE}=1 (step S711 in FIG. 7).

The CPU 341 loads the gain G(ω_{RANGE})ᵢ and the voiced sound/unvoiced sound determining variable Flag_{VorUV}(ω_{RANGE})ᵢ of band ω_{RANGE} into the built-in general-purpose register (not shown) from the storage unit 345 (step S713). When ω_{RANGE}=1 is set, for example, the gain G(1)ᵢ of band 1 and the voiced sound/unvoiced sound determining variable Flag_{VorUV}(1)ᵢ of band 1 are loaded.

Next, the CPU 341 determines if the loaded voiced sound/unvoiced sound determining variable Flag_{VorUV}(ω_{RANGE})ᵢ is Flag_{VorUV}(ω_{RANGE})ᵢ=“V” (step S715). That is, the CPU 341 determines if the original residual signal D(ω_{RANGE})ᵢ is a voiced sound.

When the original residual signal D(ω_{RANGE})ᵢ is a voiced sound, the pitch frequency Pitch(ω_{RANGE})ᵢ is generated by the voiced/unvoiced discrimination and pitch extraction unit 137 (FIG. 1) of the speech coding/decoding apparatus 311 of the sender side in step S623 in FIG. 6. Accordingly, the pitch frequency Pitch(ω_{RANGE})ᵢ should have been stored in the storage unit 345 of the speech coding/decoding apparatus 311 of the receiver side. When the original residual signal D(ω_{RANGE})ᵢ is a voiced sound (step S715: Yes), therefore, the CPU 341 loads the pitch frequency Pitch(ω_{RANGE})ᵢ into the built-in general-purpose register (not shown) from the storage unit 345 (step S717). When Flag_{VorUV}(1)ᵢ=“V” is set, for example, the pitch frequency Pitch(1)ᵢ of band 1 is loaded.

Subsequently, a work of restoring the residual signal is executed. The CPU 341 generates a pulse sequence D′(ω_{RANGE})ᵢ={d′(ω_{RANGE})_{i,0}, d′(ω_{RANGE})_{i,1}, . . . , d′(ω_{RANGE})_{i,1-1}} whose level is the gain G(ω_{RANGE})ᵢ and whose period is the reciprocal of the pitch frequency Pitch(ω_{RANGE})ᵢ (step S719). The pulse sequence D′(ω_{RANGE})ᵢ of band ω_{RANGE} is the restored residual signal of a voiced sound. The individual elements (d′(ω_{RANGE})_{i,0}, d′(ω_{RANGE})_{i,1}, . . . , d′(ω_{RANGE})_{i,l-1}) in the pulse sequence D′(ω_{RANGE})ᵢ are generated at the same time intervals as the sampling intervals of the individual elements of the original residual signal D(ω_{RANGE})ᵢ.

Therefore, the individual elements (d′(ω_{RANGE})_{i,0}, d'(ω_{RANGE})_{i,1}, . . . , d′(ω_{RANGE})_{i,l-1}) in the pulse sequence D′(ω_{RANGE})ᵢ are laid out in the time sequential order. What is more, in the sequence of time-sequentially arranged elements, the element having a value G(ω_{RANGE})ᵢ appears at an interval corresponding to the pitch period which is the reciprocal of the pitch frequency Pitch(ω_{RANGE})ᵢ, and the other elements take a value of 0.

When it is determined in step S715 that the original residual signal D(ω_{RANGE})ᵢ is not a voiced sound (step S715: No), the original residual signal D(ω_{RANGE})ᵢ is an unvoiced sound. Through predetermined procedures, therefore, the CPU 341 generates an adequate noise sequence D′(ω_{RANGE})ᵢ={d′(ω_{RANGE})_{i,0}, d′(ω_{RANGE})_{i,2}. . . , d′(ω_{RANGE})_{i,l-1}} as noise of band ω_{RANGE} while reflecting the gain G(ω_{RANGE})ᵢ (step S721). The noise sequence D′(ω_{RANGE})ᵢ of band ω_{RANGE} is the restored residual signal of an unvoiced sound.

The predetermined procedures for the noise sequence generating process will be explained later referring to FIG. 8.

Even when the original residual signal D(ω_{RANGE})ᵢ is a voiced sound or even when the original residual signal D(ω_{RANGE})ᵢ is an unvoiced sound, the band-by-band pseudo residual signal D′(ω_{RANGE})ᵢ={d′(ω_{RANGE})_{i,0}, d′(ω_{RANGE})_{i,1}, . . . , d′(ω_{RANGE})_{i,l-1}} which is a pulse sequence or noise sequence is generated. The CPU 341 stores this band-by-band pseudo pulse sequence D′(ω_{RANGE})ᵢ in the storage unit 345 to be used later in reproduction of a speech signal (step S723).

Through the processes of the steps S713 to S723, when ω_{RANGE}=1 is set, for example, the pseudo residual signal D′(1)ᵢ of band 1 which is a pulse sequence or noise sequence is stored in the storage unit 345.

Subsequently, the CPU 341 discriminates whether the processes of S713 to S723 have been executed for all the bands (step S725). Specifically, the CPU 341 discriminates whether restoring the residual signal (in other words, generation of a pseudo residual signal) has been executed for all the bands. When the processes have been executed for all the bands (step S725: Yes), the CPU 341 terminates the band-by-band excitation generating process. When there remains any unprocessed band (step725: No), the CPU 341 increments the band identification variable ω_{RANGE} by 1 (step S727) and repeats the processes of steps S713 to S725 to generate a pseudo residual signal of a next band.

In this manner, a pulse sequence or noise sequence is generated band by band.

Noise Sequence Generating Process

Specific procedures of generating a noise sequence in step S721 in FIG. 7 will be explained below referring a flowchart illustrated in FIG. 8. It is premised on that the band identification variable ω_{RANGE} has been set in step S711 or S727 in FIG. 7, and the gain G(ω_{RANGE})ᵢ has been loaded in step S713.

First, the CPU 341 generates a basic noise sequence Rᵢ={R_{i,0}, R_{i,1}, . . . , R_{i,1-1}} which has a random period and whose level is +1 or −1 (step S811).

The individual elements (R_{i,0}, R_{i,1}, . . . , R_{i,l-1}) in the basic noise sequence Rᵢ are generated at the same time intervals as the sampling intervals of the individual elements of the original residual signal D(ω_{RANGE})ᵢ. Therefore, the individual elements (R_{i,0}, R_{i,1}, . . . , R_{i,1-1}) in the basic noise sequence Rᵢ are arranged in the time sequential order. What is more, in the sequence of time-sequentially arranged elements, an element having a value of +1 or −1 appears at random intervals, and other elements take a value of 0.

The CPU 341 puts the generated basic noise sequence Rᵢ through a band-pass filter which acquires a component of band ω_{RANGE} to generate a basic noise sequence R(ω_{RANGE})ᵢ={R(ω_{RANGE})_{i,0}, R(ω_{RANGE})_{i,1}, . . . , R(ω_{RANGE})_{i,l-1}} of band ω_{RANGE} (step S813).

The CPU 341 multiplies the generated basic noise sequence R(ω_{RANGE})ᵢ of band ω_{RANGE} by the gain G(ω_{RANGE})ᵢ to generate a noise sequence D′(ω_{RANGE})ᵢ={d′(ω_{RANGE})_{i,0}, d′(ω_{RANGE})_{i,1}, . . . , d′(ω_{RANGE})_{i,l-1}} of band ω_{RANGE} (step S815). Then, the CPU 341 terminates the noise sequence generating process.

Speech Signal Restoring Process

A speech signal restoring process that is executed by the synthesis inverse filter calculation unit 235 and the synthesis inverse filter unit 225 in FIG. 2 will be explained below referring a flowchart illustrated in FIG. 9. The following is the description of a case where the MLSA-based predictive analysis (FIG. 4) is employed as a predictive analysis. When other predictive analyses like the linear predictive analysis (FIG. 5) are employed, the speech signal restoring process can be performed in similar procedures. As has already been described, the functions of the synthesis inverse filter calculation unit 235 and the synthesis inverse filter unit 225 are realized by the CPU 341 (FIG. 3).

It is assumed that the predictive coefficient (MLSA filter coefficient) Mᵢ={m_{i,0}, m_{i,1}, . . . , m_{i,p-1}} (i being an integer in the range of 0≦i≦M−1), decoded by the decoder 223, has already been stored in the storage unit 345 (FIG. 3). Further, the pseudo residual signal D′ᵢ={d′_{i,0}, d′_{i,1}, . . . , d′_{i,l-1}} (i being an integer in the range of 0≦i≦M−1), restored by the residual signal restore unit 233, has already been stored in the storage unit 345 (FIG. 3).

The CPU 341 uses the built-in counter register (not shown) as an input signal sample counter which counts a value i. When the speech signal restoring process starts, the CPU 341 sets the value i of the input signal sample counter to the initial value of i=0 (step S911 in FIG. 9).

The CPU 341 loads the predictive coefficient Mᵢ={m_{i,0}, m_{i,1}, . . . , m_{i,p-1}} according to the value i of the input signal sample counter into the built-in general-purpose register (not shown) from the storage unit 345 (step S913). When the input signal sample counter is set to i=0, for example, a predictive coefficient M₀={m_{0,0}, m_{0,1}, . . . , m_{0,p-1}} is loaded.

Next, the CPU 341 calculates a synthesis inverse filter CIMᵢ (an inverse filter CIMᵢ for synthesis) from the loaded predictive coefficient Mᵢ={m_{i,0}, m_{i,1}, . . . , m_{i,p-1}} (step S915). The process of step S915 is executed by the synthesis inverse filter calculation unit 235 in FIG. 2. The synthesis inverse filter may be acquired by using an arbitrary known scheme.

Then, the CPU 341 loads the pseudo residual signal D′ᵢ=(d′_{i,0}, d′_{i,1}, . . . , d′_{i,l-1}} into the built-in general-purpose register (not shown) from the storage unit 345, and puts the pseudo residual signal D′ᵢ through the synthesis inverse filter CIMᵢ to restore a speech signal S′ᵢ={s′_{i,0}, s′_{i,1}, . . . , s′_{i,l-1}} (step S917). An arbitrary known scheme may be used to put the pseudo residual signal through the synthesis inverse filter.

The CPU 341 stores the restored speech signal S′ᵢ={s′_{i,0}, s′_{i,1}, . . . , s′_{i,l-1}} in the storage unit 345 (step S919).

Through the processes of the steps S913 to S919, when the input signal sample counter is set to i=0, for example, a speech signal S′₀={s′_{0,0}, s′_{0,1}, . . . , s′_{0,l-1}} is stored in the storage unit 345.

Subsequently, the CPU 341 determines if the value i of the input signal sample counter has reached M−1 (step S921). When i≧M<1 (step S921: Yes), in which case all the speech signals have been restored, the CPU 341 terminates the speech signal restoring process. When i<M−1 (step S921: No), the CPU 341 increments i by 1 (step S923) and repeats the processes of steps S913 to S921 to restore a speech signal in a next time zone.

Next, an example of procedures of calculating the MLSA filter coefficient Mᵢ from the cepstrum Cᵢ in step S417 in FIG. 4 will be explained below.

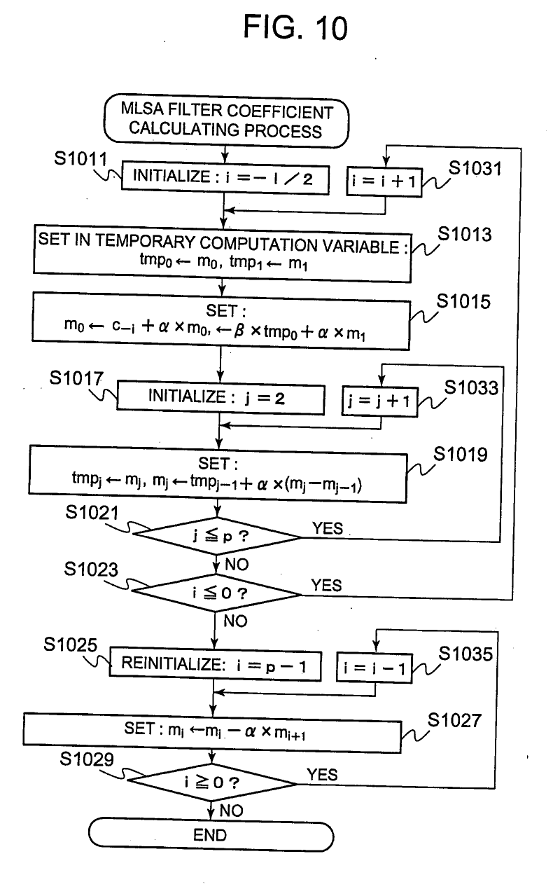

FIG. 10 is a flowchart illustrating an example of an MLSA filter coefficient calculating process. The CPU 341 performs calculation according to the flow illustrated in steps S1011 to S1035 in FIG. 10 to acquire the MLSA filter coefficient Mᵢ={m_{i,0}, m_{i,1}, . . . , m_{i,p-1}} from the cepstrum Cᵢ={c_{i,0}, c_{i,1}, . . . , c_{i,1/2-1}}. In FIG. 10, α is a value for approximation. With a speech signal being sampled at 10 kHz, it is suitable to set α=0.35. Further, β=1−α². mᵢ(0≦m≦p−1) should be initialized to 0.

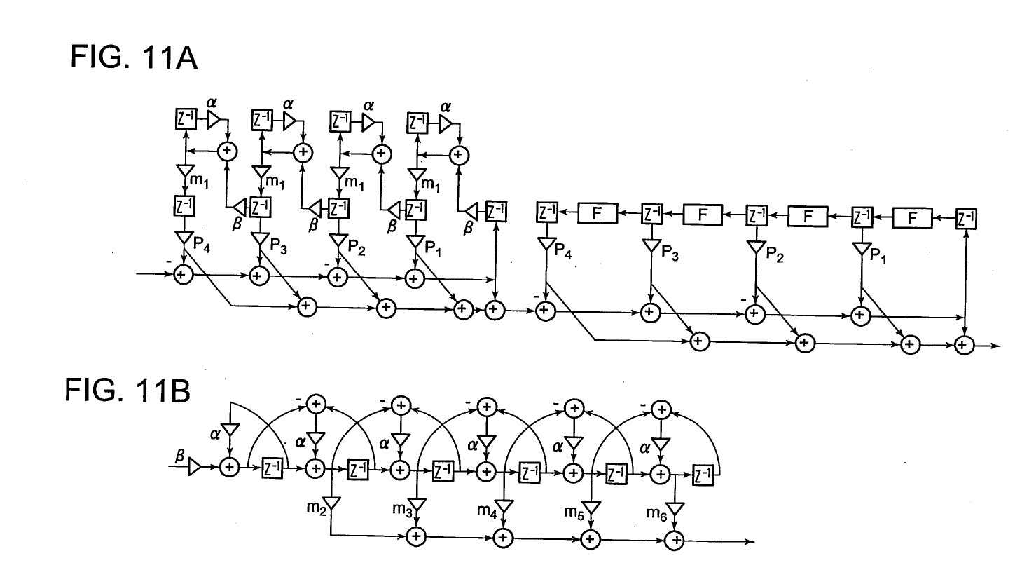

FIGS. 11A and 11B show an example of the structure of the MLSA filter using the MLSA filter coefficient acquired in the above-described manner. P₁ to P₄ are approximation coefficients. For example, it is suitable to set P₁=0.4999, P₂=0.1067, P₃=0.0117, and P₄=0.0005656.

As has been explained above, the speech coding apparatus 111 according to the embodiment codes information on what intensity a residual signal has for each band, together with the residual signal, when the speech coding apparatus 111 codes the residual signal. Therefore, a more adequate excitation signal (pseudo residual signal) can be acquired by using the information in the speech decoding apparatus 211. Further, the quality of a speech can be enhanced as a speech signal is decoded using the excitation signal.

When the residual signal is divided into a plurality of bands, there are a band where the property as a voiced sound appears strongly and a band where the property as an unvoiced sound appears strongly. Therefore, the speech coding apparatus 111 according to the embodiment discriminates for each band if the band-by-band residual signal is a voiced sound or unvoiced sound, and codes the result of the discrimination. According to the embodiment, therefore, a residual signal coded according to the band-by-band feature can be transferred to the speech decoding apparatus, thus enhancing the quality of a speech to be decoded.

A voiced sound is featured by the pitch frequency. In the speech coding apparatus 111 according to the embodiment, therefore, when a residual signal of a given band has a property as a voiced sound, a pitch frequency is extracted from the residual signal of the band, and the residual signal of the band is typified by the pitch frequency. Therefore, the embodiment, can reduce the amount of information to be coded while keeping the feature of the band. Further, the reduction in the amount of information is advantageous in low-bit rate communication.

The speech coding apparatus 111 according to the embodiment discriminates if a band-by-band residual signal is a voiced sound or unvoiced sound, based on the shape of the auto correlation function of the band-by-band residual signal. As the embodiment uses a predetermined criterion in discrimination, therefore, it is possible to easily discriminate if the residual signal is a voiced sound or unvoiced sound. When it is determined that the residual signal is a voiced sound, the pitch frequency can be acquired at the same time.

The speech coding apparatus 111 according to the embodiment performs the MLSA-based predictive analysis or linear predictive analysis. The embodiment can therefore make an analysis synthesis type speech compression suitable for a low bit rate.

The speech decoding apparatus 211 according to the embodiment generates an excitation signal reflecting the band-by-band residual signal intensity given from the speech coding apparatus 111 and restores a speech signal based on the excitation signal. According to the embodiment, therefore, the excitation signal, like an intrinsic human speech, has a feature band by band. This makes it possible to decode a high-quality speech signal.

The present invention is not limited to the above-described embodiment, and can be modified and adapted in various forms. The above-described hardware configurations, block structures and flowcharts are just examples and not restrictive.

For example, the speech coding/decoding apparatus 311 shown in FIG. 3 is assumed to be a cellular phone. However, the present invention can also be adapted to speech processing in a PHS (Personal Handyphone System), PDA (Personal Digital Assistance), notebook and desktop personal computers, and the like. When the invention is adapted to a personal computer, for example, a speech input/output device, a communication device, etc. should be added to the personal computer. This can provide the computer with the hardware functions of a cellular phone. As the computer program that allows the computer to execute the above-described processes is distributed in the form of a recording medium recording the program or over a communication network and is installed on, and executed by, a computer, the computer can function as the speech coding apparatus or the speech decoding apparatus according to the invention.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2006-214741 filed on Aug. 7, 2006 and including specification, claims, drawings and summary. The disclosure of the above Japanese Patent Application is incorporated herein by reference in its entirety.

What is claimed is:

1. A speech coding apparatus comprising:
a predictive analyzer that performs a predictive analysis on a speech signal to acquire a predictive coefficient and a residual signal;
a band-by-band residual signal generating unit that separates the residual signal into band-by-band residual signals for respective bands;
an intensity determining unit that acquires band-by-band residual signal intensities from the band-by-band residual signals for the respective bands; and
a coder that codes the predictive coefficient and the band-by-band residual signal intensities for the respective bands.

2. The speech coding apparatus according to claim 1, further comprising a voiced/unvoiced discrimination unit that discriminates for each of the bands whether the band-by-band residual signal is a voiced sound or unvoiced sound,
wherein the coder further codes a result of discrimination done by the voiced/unvoiced discrimination unit.

3. The speech coding apparatus according to claim 2, further comprising a pitch extraction unit that extracts a band-by-band pitch frequency from that band-by-band residual signal which has been discriminated as a voiced sound by the voiced/unvoiced discrimination unit,
wherein the coder further codes the band-by-band pitch frequency extracted by the pitch extraction unit.

4. The speech coding apparatus according to claim 2, wherein the voiced/unvoiced discrimination unit discriminates for each of the bands whether the band-by-band residual signal is a voiced sound or unvoiced sound based on a shape of an auto correlation function of the band-by-band residual signal.

5. The speech coding apparatus according to claim 1, wherein the predictive analysis is MLSA (Mel Log Spectrum Approximation) analysis, the predictive coefficient is an MLSA filter coefficient, and the residual signal is a signal acquired as an inverse filter output of an MLSA filter.

6. The speech coding apparatus according to claim 1, wherein the predictive analysis is linear predictive analysis, the predictive coefficient is a linear predictive coefficient, and the residual signal is a signal acquired as an inverse filter output of a linear predictive filter.

7. A speech decoding apparatus comprising:
a receiver that receives a coded predictive coefficient obtained by coding a predictive coefficient acquired by a predictive analysis on a speech signal, and coded band-by-band residual signal intensities obtained by coding band-by-band residual signal intensities respectively indicating intensities for respective bands of a residual signal acquired by the predictive analysis;
a decoder that decodes the predictive coefficient and the band-by-band residual signal intensities for the respective bands from the coded predictive coefficient and the coded band-by-band residual signal intensities;
an excitation signal generating unit that generates, for each of the bands, a band-by-band excitation signal having a band dependency indicated by the-band-by-band residual signal intensity;
a residual signal restore unit that restores a residual signal from the band-by-band excitation signals for the respective bands; and
a synthesis filter that combines the predictive coefficient and the restored residual signal to restore a speech.

8. A speech coding method comprising:
a predictive analysis step of performing a predictive analysis on a speech signal to acquire a predictive coefficient and a residual signal;
a band-by-band residual signal generating step of separating the residual signal into band-by-band residual signals for respective bands;
an intensity determining step of acquiring band-by-band residual signal intensities from the band-by-band residual signals for the respective bands; and
a coding step of coding the predictive coefficient and the band-by-band residual signal intensities for the respective bands.

9. A speech decoding method comprising:
a reception step of receiving a coded predictive coefficient obtained by coding a predictive coefficient acquired by a predictive analysis on a speech signal, and coded band-by-band residual signal intensities obtained by coding band-by-band residual signal intensities respectively indicating intensities for respective bands of a residual signal acquired by the predictive analysis;
a decoding step of decoding the predictive coefficient and the band-by-band residual signal intensities for the respective bands from the coded predictive coefficient and the coded band-by-band residual signal intensities;
an excitation signal generating step of generating, for each of the bands, a band-by-band excitation signal having a band dependency indicated by the band-by-band residual signal intensity;
a residual signal restore step of restoring a residual signal from the band-by-band excitation signals for the respective bands; and
a synthesis step of combining the predictive coefficient and the restored residual signal to restore a speech.

10. A computer readable recording medium having recorded therein a program for allowing a computer to execute:
a predictive analysis step of performing a predictive analysis on a speech signal to acquire a predictive coefficient and a residual signal;
a band-by-band residual signal generating step of separating the residual signal into band-by-band residual signals for respective bands;
an intensity determining step of acquiring band-by-band residual signal intensities from the band-by-band residual signals for the respective bands; and
a coding step of coding the predictive coefficient and the band-by-band residual signal intensities for the respective bands.

11. A computer readable recording medium having recorded therein a program for allowing a computer to execute:
a reception step of receiving a coded predictive coefficient obtained by coding a predictive coefficient acquired by a predictive analysis on a speech signal, and coded band-by-band residual signal intensities obtained by coding band-by-band residual signal intensities respectively indicating intensities for respective bands of a residual signal acquired by the predictive analysis;
a decoding step of decoding the predictive coefficient and the band-by-band residual signal intensities for the respective bands from the coded predictive coefficient and the coded band-by-band residual signal intensities;
an excitation signal generating step of generating, for each of the bands, a band-by-band excitation signal having a band dependency indicated by the band-by-band residual signal intensity;
a residual signal restore step of restoring a residual signal from the band-by-band excitation signals for the respective bands; and
a synthesis step of combining the predictive coefficient and the restored residual signal to restore a speech.
